(19) United States
(12) Patent Application Publication
(10) Pub. No.: US 2015/0132729 A1
(43) Pub. Date: May 14, 2015

(54) System and method for a Reducing Recidivism

(71) Applicant: Robert Hust, Coeur dAlene, ID (US)

(72) Inventor: Robert Hust, Coeur dAlene, ID (US)

(21) Appl. No.: 14/080,765

(22) Filed: Nov. 14, 2013

(51) Int. Cl. G09B 19/00

(52) U.S. Cl. CPC G09B 19/00
USPC 434/236

(57) ABSTRACT

This invention describes a journaling and graphing application that easily collects thoughts, data and feelings and relates them to a support community and flexible calendar. The application then presents data relating to events, challenges, and attitudes as either conducive to recovery, or antithetical to recovery and encourages good behavior through feedback, notifications and game dynamics. The application is comprised of six primary feature sets—journaling, community networking, polling and alerting, gamification, care paradigm and feedback. The system uses and co-occurrence and correlation of events over time to establish a predictive analysis of outcomes and to flag good and bad influences.

### CROSS REFERENCE TO RELATED APPLICATIONS

This application claims the benefit of provisional patent application Ser. No. 61/726,524 filed 2012 Nov. 14 by the present inventor.

The invention of this method involves no Federal, or publicly sponsored research.

### BACKGROUND OF THE INVENTION

1. Field of Invention

This invention generally relates to social networks and mobile computing as well as individual mental health, addiction, and treatment.

2. Prior Art

Previously, recidivism rates for treatment have been addressed with humanitarian and legal mechanisms including counseling, group therapies, medical treatments and so on and so forth with varying degrees of success or failure respectively. Counseling and Treatment Centers focus on in-patient and out-patient structure, curricula and education, as well as possible pharmaceutical treatments. Group therapies, and structured support associations like Alcoholics Anonymous focus on support, communication and sponsorship. Medical and Pharmaceutical treatments focus on reducing desire, and using chemicals to alter brain chemistry. The positive result of these combined approaches on recidivism is less than ten percent. While the invention is akin to a medical device or application, in differs in that it focusses on feelings and behaviors rather than sensor or feedback based physical measurements, regiments, or policing.

The invention described is different from the aforementioned as well in that it is comprised of a user interface and components that act together as a system to actively change the behavior of any person or body that may find themselves in a recidivistic state. It further differs in that any measurements are of a subjective nature, designed to support consistent improvement of behavior, thus reducing recidivism. It further differs in that it offers an intrinsic reward system, that assists individuals by replacing the rewards available through recidivism with rewards available via applications of the strategies available in the invention.

### Objects and Advantages

Accordingly, several objects and advantages of the invention follow. The invention enables individuals to access assistance at any time, at their convenience. The invention enables users to better communicate events, challenges, goals, and setbacks to individuals and bodies that can assist in reducing recidivism. The invention enables treatment providers to monitor an individual's success in a non-invasive manner. The invention allows care providers and institutions to consistently improve care through subjective feedback measurements.

Further objects and advantages will become apparent from a consideration of the ensuing description.

### SUMMARY

This invention describes a journaling and graphing application that easily collects thoughts, data and feelings and relates them to a support community and flexible calendar. The application then presents data relating to events, challenges, and attitudes as either conducive to recovery, or antithetical to recovery and encourages good behavior through feedback, notifications and game dynamics, The application is comprised of six primary feature sets—journaling, community networking, polling and alerting, gamification, care paradigm and feedback.

### BRIEF DESCRIPTION OF SEVERAL VIEWS OF THE DRAWINGS

FIG. 1.—Field of colored shapes corresponding to events spread across the timeline, arranged by attitude, sized by magnitude.

FIG. 2.—Add event dialog for choosing a journal entry, a challenge event or a goal.

FIG. 3.—Journal entry panel showing attitude, magnitude, ease, share, and afterthought buttons as well as title, body, and tag fields.

FIG. 4.—Metrics panel showing ontrack-ratio, average attitude, perseverance, perseverance trend, supporter count, successful assists count, and point totals.

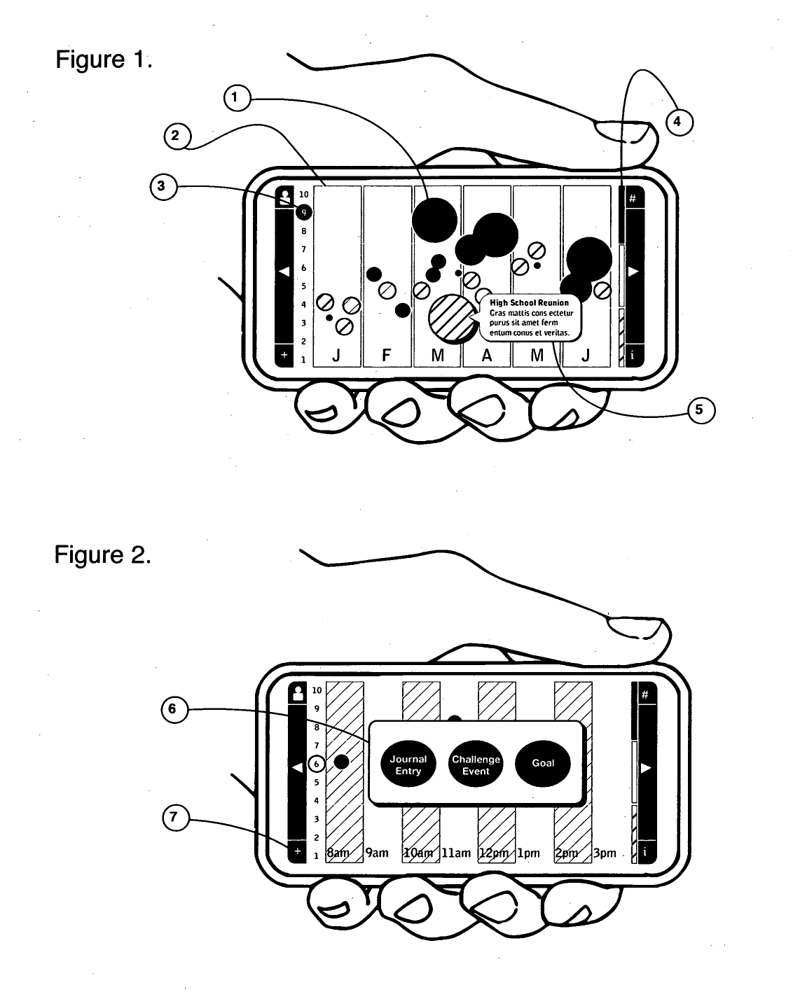

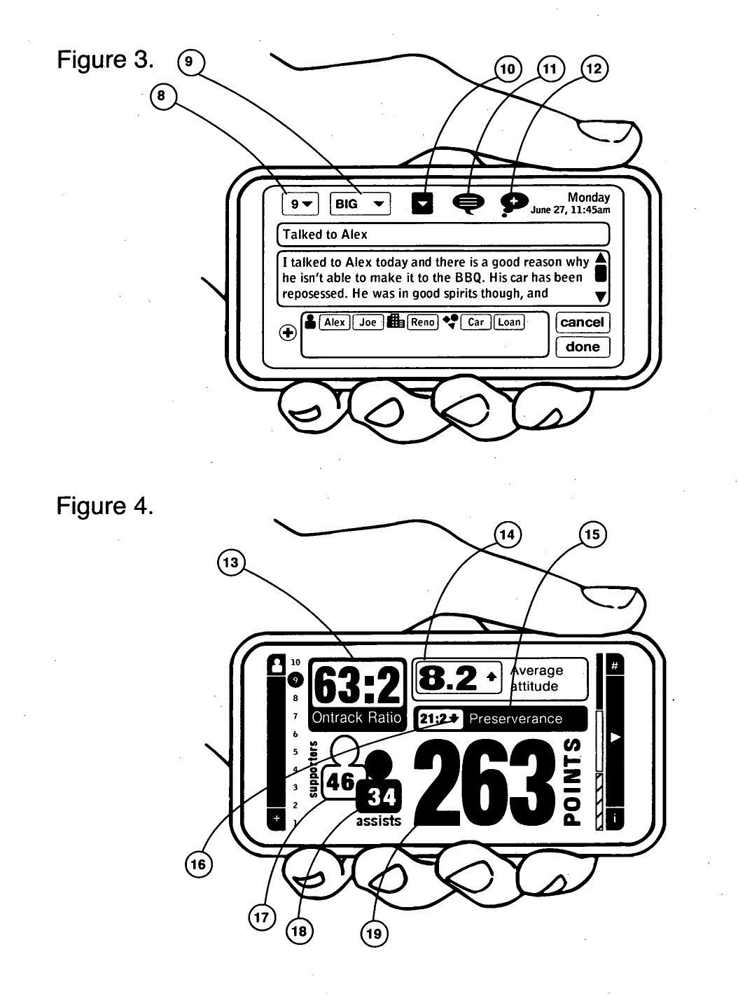

### DETAILED DESCRIPTION

This invention describes a journaling and graphing application that easily collects thoughts, data and feelings and relates and records them via a computer or mobile device interface with or without computer network transmission to a support community as well as places them within a scalable calendar. The application then presents data relating to events, challenges, and attitudes as either conducive to recovery, or antithetical to recovery via feedback provided by a rule based filter and or predicative analysis afforded by a vector machine, Bayesian network, neural net or any classifier which computes statistical probabilities of success or failure based on a total or limited history of application inputs related to journaling, challenge event outcomes, or goal attainment and encourages good behavior through game dynamics and rewards both intrinsic and otherwise.

The main body of the application is a journal mechanism that is enacted via an interface that presents 1 a field of shapes corresponding to events. These shapes appear in various sizes corresponding with a subjective assignation of importance of the event, by the author. The shapes are also color coded, corresponding to “ease” felt by the author concerning the event, from easy to challenging and or expected failure. Behind the shapes that represent events and entries, is 2 a timeline. As the timeline is expanded or compressed via appropriate input devices for computers, as well as mobile and touch-screen devices, the shapes corresponding to events move and size accordingly. Beside the field upon which the events are placed (the events field or timeline), in a column to the left is 3 a scale of integers. In the preferred embodiment, these integers are a series of one to ten, placing the highest integer (ten) at the top, Other embodiments might use a slider, up and down arrows, or a color band. This scale represents a subjective measurement of the authors attitude, with highest being the best. In a column to the right of the events field are 4 three colored bands that correspond to average attitudes, arranged such that it becomes evident that they reflect the integer values of the attitude scale mentioned above (the one to ten scale) where the author encounters “ease” such that an observer can tell what range is a likely (or historic) failure, what range is challenging, and what range is easy. It is likely that other applications might use more bands, but this preferred embodiment uses three.

Enacting (clicking or tapping on a representative shape or circle in the preferred embodiment) an event, gives 5 a “quick view” excerpt in a “speech balloon” shape that offers a brief description of the event. When the user enacts the interface (double-taps, or presses and holds, or similar commonly used interface action) to read more, the application opens the journal or event editor screen. Adding an event or journal entry is a simple action that opens a 6 selection dialog where the user chooses the type of entry they'll be adding—in the preferred embodiment, a journal entry, a challenge event, or a goal. Journal entries are entries or events similar to what a person might write in a personal journal or diary. Challenge events are upcoming timeframes wherein the user expects to face some challenge that might lead to recidivism. Goals are those events set in the future, that represent an aspiration that can be measured in a context of attainment. To add an entry, the user will either click an “add entry” button or, utilizing a touch screen, double-tap and hold (or similar commonly used interface action), anywhere on the timeline that they want to insert the entry. Entries could also be added via 7 a “plus” or “add” button available in conjunction with the timeline.

The preferred embodiment of the event or journal entry panel is a familiar user interface (text field with software keyboard for mobile devices, text field for computers) with the addition of the subjective measurement elements mentioned above—8 attitude number, 9 magnitude/size, and an 10 ease or difficulty color. Facilities for editing the date of the entry are also present. Once an entry has been made, the keyboard closes (in the case of mobile devices) and reveals a field for inserting tags representing people, places, things, or concepts that are meaningful in relation to the entry. The preferred embodiment also includes a 11. “share” button that allows the entry to be shared with members of their support circle via a network connection.

Users are not allowed to change journal or event entries, but instead are allowed to 12 create an afterthought, which is attached to the original entry. Subjective measurements may also be manipulated as part of the afterthought.

As mentioned previously, challenge events are journal entries that forecast future events or occurrences that pose a challenge to an individual's ability to avoid recidivism. Challenge events are shared with an individual's defined support circle as notifications sent at a specified time previous to the defined event, giving others a chance to offer encouragement, or engage the individual in supportive dialog. Encouragements are an element of gamification that allows a user to offer points to other users, subtracted from their own totals, as a means to incentivize success.

Within the system, “setback alerts” are notifications sent to an individual's support network whenever a “failure” has occurred. A setback alert, distributed via a network connection, gives a supporter or counselor an immediate opportunity to engage the user who suffered the setback in conversation, offering support, and advice to the individual to assist them through a difficult period.

Another notification type sent as a push poll by the system are “registry questions.” The preferred embodiment is that the registry questions, based on invasiveness or importance and value of the answer, are given a point value that is earned by the user when the questions are answered. This allows for the collection of timely high value, high veracity data.

One of the features of this invention is the element of care paradigms. Many paradigms exist and will be supported through a simple API. The preferred embodiment uses those paradigms proscribing that a person is only healthy when all the criteria are in balance. As with journal and event entries, the elements of the care paradigm are shapes given a size representing personal importance, an “ease” color representing attainment/attainability, and are arranged in order of importance by the user. Tags representing markers of attainment of the paradigm elements can be added via journal entries. Attainment is represented analogous to ease, and a background color is assigned to the field illustrating the average attainment level of all paradigm elements over a specified period.

The preferred embodiment of the invention includes the following game mechanics and metrics as they provide affirmation support, as well as stimulate a pleasure response directly tied to achievement: 13 ontrack-ratio, 14 average attitude, 15 perseverance, 16 perseverance trend, 17 supporter count, 18 successful assists count, and 19 point totals. It is intended that the ontrack-ratio be further protected as a trademark. The ontrack-ratio is a ratio of successful days against unsuccessful days, where success is either a subjective or objective measurement, it is a feedback metric engineered to encourage success. The advantage of an ontrack-ratio over days sober, and therefore the difference between the two is that the ontrack-ratio eschews the negative aspects of highlighting failure. The average attitude is an average of all attitude scale inputs of a specified timeframe as related to sobriety. Perseverance is a ratio of successful challenge events vs unsuccessful challenge events, the perseverance trend (up or down) represents whether the individual is getting better or worse at overcoming challenges. The number of supporters represents the number of participants in an individual's support circle/community. The number of assists represents how many successful challenge events that an individual has helped others through by offering incentive points. The points are represented as two totals—all points over the course of interaction, and a current balance.

The invention presents historical data, in the form of charts, graphs, and reports. This is an important aspect of the invention in terms of introspection and encouragement. Users can reflect on past performance, and view progress toward goals. Counselors will have the ability to select which data visualization elements are available to patients.

The preferred embodiment of the invention represents the individuals support community via a dashboard the shows a graphic representation of each individual, with point totals, perseverance, attitude, and attitude trends clearly marked for each. Also available are buttons that enact an activity stream, a record of all alerts, a record of assists and encouragements as well as any points they gave to incentivize outcomes, a mechanism to access a group panel allowing a user to create subgroups of their overall support circle and allowing greater control over sharing and privacy while fostering appropriate and beneficial interaction, and an element to allow the addition of supporters.

The preferred embodiment also offers a control panel that lets users quickly access a set of emergency phone numbers for rapid access, interface legend, usage tips, pop-up help settings, care paradigm selection with on-off, registry (push-poll) on-off, logout and authentication settings.

1. What is claimed is a journaling and graphing application that easily collects thoughts, data and feelings and relates them to a support community and flexible calendar wherein the application accepts and presents data relating to events, challenges, and attitudes as either conducive to recovery, or antithetical to recovery and encourages behavioral changes in the user through game dynamics and personal feedback.

2. As in claim one and the calendar is represented as subjectively sized, and colored shapes representing events plotted by attitude across a finite timeline of variable scale.

3. As in claims one and two with the metrics of ontrack-ratio. average attitude. perseverance, perseverance trend, supporter count, successful assists count, and point totals used either individually or collectively as elements of encouragement and or game dynamics.

4. As in claim one and having an added element of predictive analysis comprised of any mechanism allowing for concordance, co-occurrence, or likelihood estimation involving success or failure based on historic data.

5. As in claims one through four and having an added element of predictive analysis comprised of any mechanism allowing for concordance, co-occurrence, or likelihood estimation involving success or failure based on historic data.

6. As in claim five with the addition of alerts and notifications triggered by the predictive analysis.

7. As in claims one through six particularly for use in aftercare for addiction or mental health treatment.

8. As in claims one through six but particularly for use in self-help and personal improvement.

9. What is claimed is a computer interface for quickly representing and manipulating journal events, emotional attitude, relative ease of the events, and subjective magnitude of the event where the events are arranged on a timeline with directional representation from past to future running left to right or right to left or top to bottom or bottom to top or clockwise or counter clockwise, with placement corresponding to a time and an attitude, and colored according to ease, difficulty or other expectation, and sized based on subjective magnitude.

10. What is claimed is a computer interface for creating a journal entry that can be classified as a journal entry, a challenge event or a goal where one, any, or all of these are recorded in conjunction with an attitude measurement or an analogue of attitude, ease measurement or analogue of ease, and magnitude measurement or a analogue of magnitude.

11. As in claim ten where with attitude or a analogue of attitude, ease or analogue of ease, and magnitude or a analogue of magnitude are used in conjunction with timing or correlative data for predictive analysis of the success or failure of future challenges or goals.

12. As in claim eleven with the recognition of tags or keywords as correlative data to assist in predictive analysis.
